(19) United States
(12) Patent Application Publication
(10) Pub. No.: US 2011/0088526 A1
(43) Pub. Date: Apr. 21, 2011

(54) SHEET CUTTING APPARATUS

(75) Inventors: Hideaki NONAKA, TOKYO (JP); Kan NAKATA, TOKYO (JP); Yoshiaki SUGISHITA, TOKYO (JP); KENJI KOBAYASHI, TOKYO (JP)

(73) Assignee: LINTEC CORPORATION, TOKYO (JP)

(21) Appl. No.: 12/979,481

(22) Filed: Dec. 28, 2010

Related U.S. Application Data
(63) Continuation of application No. 11/995,452, filed on Jan. 11, 2008.

(30) Foreign Application Priority Data
Aug. 8, 2005 (JP) 2005-229224

(51) Int. Cl. B26D 7/10; B26D 7/27

(52) U.S. Cl. 83/168; 83/171

(57) ABSTRACT

A sheet cutting apparatus includes a cutting device and at least one cutter blade to be mounted detachably on the cutting device. The cutter blade has a blade holder and a blade fixed to the blade holder. The apparatus further includes a stocking device for storing the at least one cutter blade. The stocking device includes a case body, a receiving section in the case body, and a heater. The receiving section has a blade holder receiving portion for storing the blade holder and a blade receiving portion for storing the blade. The heater is arranged for heating the blade holder and the blade of the cutter blade in the receiving section. The cutting device is arranged for using the cutter blade heated by the heater.

### RELATED APPLICATIONS

This is a Continuation Application of U.S. application Ser. No. 11,995,452, filed on Jan. 11, 2008, which is based on, and claims priority from, International Application Number PCT/JP2006/314485 filed, Jul. 21, 2006 and Japanese Application Number 2005-229224, filed Aug. 8, 2005.

### FIELD OF THE INVENTION

The present invention relates to a stock device for cutter blades, particularly to a stock device for cutter blades capable of storing the cutter blades so that the cutter blades are oriented or directed in a constant direction for the occasion when a cutter blade is mounted onto a cutting device, as well as capable of performing maintenance and inspection of the cutter blades when the cutter blades are stored therein.

### BACKGROUND OF THE ART

Conventionally, an adherend such as semiconductor wafer (hereinafter, simply referred to as “wafer”) is stuck with a protective sheet for protecting circuit surface thereof.

In a sticking method of the sheet as described above, in a case where such a raw strip sheet that a strip sheet is temporarily stuck on a strip of release liner is used, the sheet has to be cut off along the periphery of the wafer with a cutting device after the sheet is peeled off from the release liner and stuck onto the wafer.

JP2919938 discloses a cutting device for cutting a sheet stuck on a wafer is disposed above a sheet sticking table. The cutting device comprises an arm having its rotation center on the center line of the wafer and a cutter blade attached to the front end of the arm.

Also, JP H06-335893 discloses a cutting device constituted of a robot equipped with a cutter blade at the free-end side thereof.

However, each of the cutting devices disclosed above does not include any maintenance function for stabilizing the cutting accuracy by the cutter blade, and the cutting devices are not arranged so as to cope with the time-varying deterioration of the cutter blade accuracy.

Also, in the arrangement disclosed in JP H06-335893, although the cutting device is constituted of the robot, such arrangements are not included that the cutter blade can be picked up to be mounted from a stocker which stores a plurality of cutter blades, or the cutter blades are kept to be oriented or directed in a constant direction in a case where the cutting device replaces the cutter blade automatically.

### SUMMARY

The present invention has been proposed in view of the above disadvantages. It is an object of the present invention to provide a stock device for cutter blades capable of stably maintaining the cutting accuracy of the cutter blade.

Another object of the present invention is to provide a stock device for cutter blades that maintains a stored posture of the cutter blades to be constant, and thereby the relative position thereof with respect to the cutting device on which the cutter blade is mounted is maintained to be constant so that the orientation of the blade corresponds to the traveling track of the cutting device.

To achieve the above objects, the present invention adopts such an arrangement that a stock device for cutter blades to be mounted detachably onto a cutting device, comprising:

a case body for storing cutter blades, and positioning means which is provided in the case body and maintains the storing position of the cutter blades to be constant.

In the present invention, the positioning means includes an orientation determining portion formed on the cutter blade and an engagement portion provided within the case body corresponding to the orientation determining portion.

Also, the case body includes washing means for cutter blades.

The washing means may be arranged so as to contain washing liquid within the case body.

Also, the washing means may include washing liquid contained within the case body and an ultrasonic vibrating device for imparting ultrasonic vibration to the washing liquid.

Further, the washing means may be arranged with a washing brush stored within the case body.

Furthermore, such an arrangement may be adopted that heating means for heating the cutter blade is disposed within the case body.

Still further, inspection means for inspecting blades of the cutter blades maybe provided within the case body.

According to the present invention, since the positioning means is provided, the cutter blades can be stored being orientated in a constant direction. Therefore, when such an arrangement is adopted that the cutting device moves to mount the cutter blade stocked in the stock device and mounts the cutter blade automatically, the orientation of the cutter blade can be maintained to a constant direction with respect to the cutting device. For example, when the cutting device is arranged so as to perform the cutting operation along the outer periphery of an adherend, the blade has to be oriented in accordance with the track thereof. According to the present invention, since the orientation of the cutter blade stored in the stock device is maintained to be constant, the blade can be set so that, when mounted onto the cutting device, the orientation of the blade is in accordance with the track. Therefore, such disadvantage is prevented that the orientation of the blade is shifted.

Also, according to the arrangement that the case body includes the washing means for the cutter blades, even when the adhesive and the like adheres on the cutter blades, the blades can be washed while being stored in the stock device. Therefore, the cutting accuracy can be continuously maintained when the cutter blade is used next time.

Further, in a case where such an arrangement is adopted that the heating means is disposed within the case body, the cutter blade can be used in a state being heated, and thereby the cutting accuracy can be improved.

Furthermore, in the arrangement that the inspection means is provided within the case body, the blade can be inspected when the cutter blade is stored in the stock device. And when a defect is detected, such a measure can be taken as the blade is prevented from being used again.

### BRIEF DESCRIPTION OF THE DRAWINGS

FIG. 1 is a perspective view schematically showing a stock device disposed along with a cutting device for cutting a protective sheet stuck on a wafer.

FIG. 2 is a side view of a table and the cutting device.

FIG. 3 is an enlarged perspective view of a cutter blade.

FIG. 4 is a cross sectional view schematically showing the stock device.

FIG. 5 is a cross sectional view showing another example of a stock device.

FIG. 6 is a cross sectional view still another example of a stock device.

### DESCRIPTION OF THE PREFERRED EMBODIMENT

Hereinafter, embodiment of the present invention will be described with reference to the drawings.

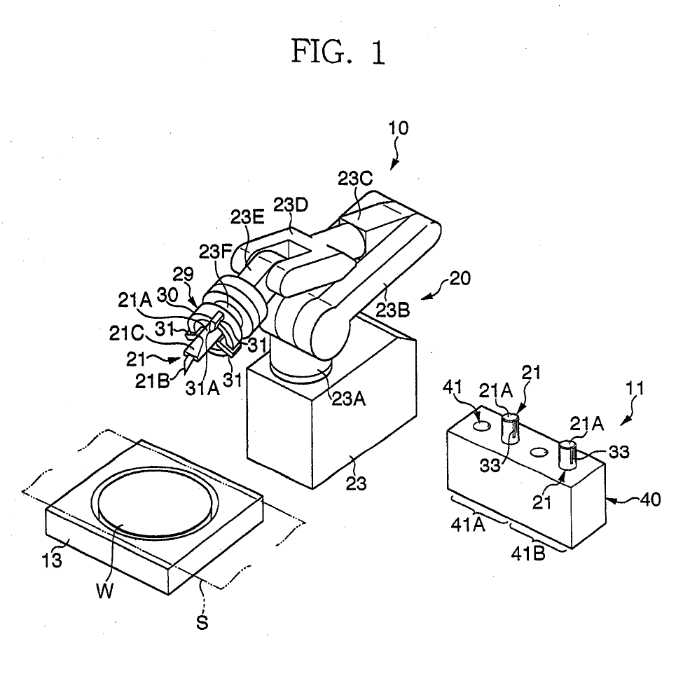

FIG. 1 is a perspective view schematically showing a stock device according to the present invention, which is disposed along with a cutting device. In FIG. 1, in the vicinity of the cutting device 10, the stock device 11 for cutter blades 21 and a table 13 for supporting a wafer W are disposed. Here, on the upper surface of the wafer W (for example, a circuit surface), a strip of protective sheet S (hereinafter, refer to as “sheet S”) is stuck, and the sheet S is arranged so as to be cut by the cutting device 10 along the outer periphery of the wafer W.

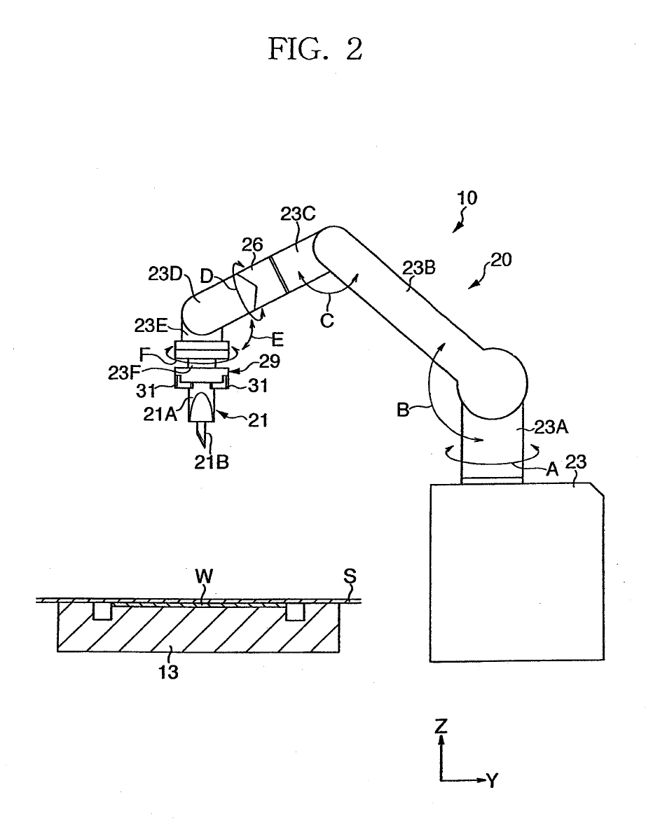

As shown in FIG. 2, the cutting device 10 comprises a robot body 20 and the cutter blade 21 supported on the free-end side of the robot body 20. The robot body 20 includes a base section 23, first to sixth arms 23A to 23F, which are disposed on the upper surface side of the base section 23 so as to be rotatable in the direction indicated with arrows A to F respectively, and a cutter blade holding chuck 29 attached to the front end side of the sixth arm 23F. Each of the second, third and fifth arms 23B, 23C, 23E is provided rotatably within a plane of Y x Z in FIG. 2; and each of the first, fourth and sixth arms 23A, 23D, 23F is provided rotatably about the axis thereof.

The cutter blade holding chuck 29 comprises a cutter blade receiver 30 having a substantially cylindrical shape and three chuck claws 31 for holding the cutter blade 21 detachably, which are disposed at the positions substantially 120° away from each other in the peripheral direction of the cutter blade receiver 30. Each of the chuck claws 31 has a pointed-edge portion 31A an inner end of which forms an acute angle, and is arranged so as to move forward/backward in the radial direction with respect to the center of the cutter blade receiver 30 with pneumatic pressure. Note that the cutting device 10 is controlled by a control device (not shown), and the control device is provided to control the movement of the cutting device 10 when cutting the sheet S and to control automatic mounting and dismounting operation of the cutter blade 21 stored in the stock device 11.

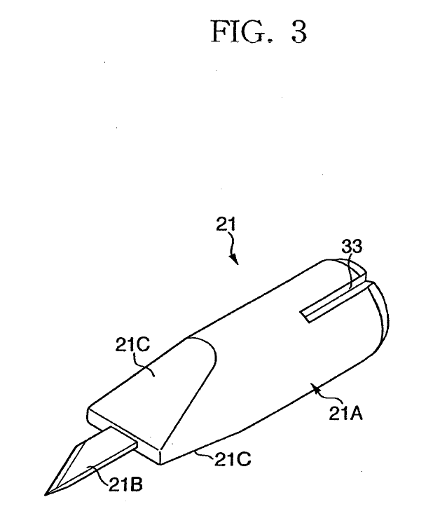

As shown in FIG. 3, the cutter blade 21 comprises a blade holder 21A and a blade 21B inserted into the front end of the blade holder 21A and fixed thereto. The blade holder 21A has a substantially cylindrical shape, and at the positions substantially 120° away from each other in the peripheral direction of the circumferential surface thereof, grooves 33 having a length extending from the base end to an intermediate portion thereof are formed along the axial direction. The position of the cutter blade 21 with respect to the cutter blade holding chuck 29 is maintained to be constant through such an arrangement as the pointed-edge portions 31A of the chuck claws 31 engage with these grooves 33. Also, in the front end side of the blade holder 21A, slant surfaces 21C and 21C as an orientation determining portion are formed in the positions opposite to each other. Although the slant surfaces 21C and 21C in the embodiment are formed symmetrically with respect to a virtual center plane of the blade holder 21A, however, the slant surfaces 21C and 21C may be formed asymmetrically.

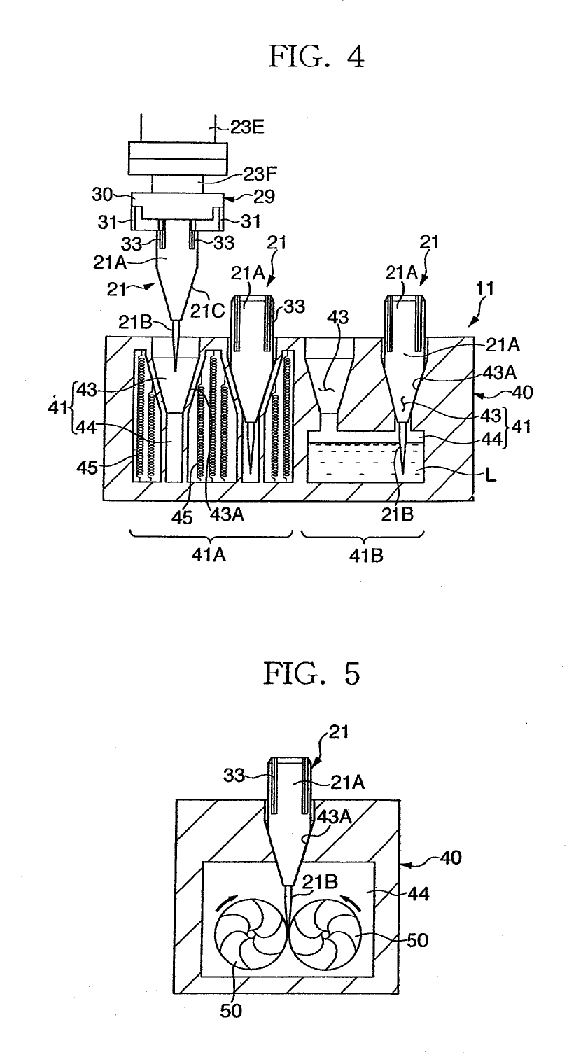

As shown in FIG. 4, the stock device 11 comprises a case body 40 and a plurality of receiving sections 41 formed in the case body 40 so as to store the cutter blades 21 independently from each other. Each of the receiving sections 41 is formed to be a shape having an open upper end with a bottom; the upper portion thereof is a blade holder receiving portion 43 and the lower portion is a blade receiving portion 44. Inner surface of the blade holder receiving portion 43 is formed with engagement surfaces 43A and 43A as an engagement portion constituting positioning means along with slant surfaces 21C and 21C of the blade holder 21A. Owing to the fact that the slant surfaces 21C and 21C are placed on these engagement surfaces 43A and 43A, the peripheral direction position of the cutter blade 21 in the receiving section 41 is managed to be at a constant position. Note that, when the slant surfaces 21C and 21C are formed asymmetrically, the engagement surfaces 43A and 43A are formed in an asymmetry shape respectively corresponding to the slant surfaces 21C and 21C. Through forming the slant surfaces 21C and 21C asymmetrically as described above, the cutter blade 21 is received and stored only in a predetermined direction. Accordingly, storing failure of the cutter blade 21 can be prevented.

In the receiving sections 41 of the stock device 11, the two at the left side in FIG. 4 are heating storage sections 41A; and the two at the right side are washing storage sections 41B. The heating storage sections 41A are provided with coil heaters 45 constituting heating means at the peripheral side thereof, and is arranged so that, when power is supplied to the coil heaters 45, heat is generated and heats up the cutter blade 21. On the other hand, in the washing storage sections 41B, the blade receiving portion 44 is formed to be a common space. In the blade receiving portion 44, organic solvent L as washing liquid, which constitutes the washing means, is contained, and is arranged so as to dissolve and remove the adhesive and the like adhered on the blade 21B with the organic solvent L. Note that the washing storage section 41B is arranged so as to ensure constantly a space for washing the blade 21B of the cutter blade 21 after the cutter blade 21 is repeatedly and continuously used for sheet cutting operation.

Next, the working of the embodiment will be described.

After the sheet S is stuck on the wafer W supported on the table 13 as shown in FIG. 2, the cutter blade 21 on the cutting device 10 moves along the outer periphery of the wafer W to cut the sheet S at the outside of the wafer W as an unnecessary sheet portion.

When the sheet cutting operation is carried out repeatedly and continuously, it is conceivable that adhesive is transferred from sheets S onto the cutter blade 21 which has been used for cutting. Therefore, the cutter blade 21 is stored in a vacant space of the washing storage section 41B in the stock device 11, and the adhesive is dissolved and removed with the organic solvent L in the washing storage section 41. The cutter blade 21 is stored in a state that the slant surfaces 21C of the blade holder 21A match with the engagement surfaces 43A. Owing to this, the cutter blade 21 is kept in the constant direction. On the other hand, the cutter blade 21, which has been washed for a specific period of time, is transferred to the heating storage section 41A while keeping the same orientation by the cutting device 10, and is subjected to the heating process by the coil heaters 45.

In the next cutting operation, the cutting device 10 moves to pick up the cutter blade 21, which has been heated, and while keeping the constant orientation, a cutter blade 21 is mounted onto the cutter blade holding chuck 29 in a state that the orientation corresponding to the above-described traveling track can be maintained.

Therefore, according to the embodiment as described above, such stock device 11 can be provided that the cutter blade 21 can be mounted automatically in the constant orientation with respect to the cutter blade holding chuck 29 of the cutting device 10, and if necessary, the heated cutter blade 21 can be used, and adhesive or the like adhered on the cutter blade 21 can be dissolved to prevent the cutting accuracy of the blade 21B from being deteriorated.

The best arrangement and method for carrying out the present invention have been disclosed so far. However, the present invention is not limited to the above.

That is, the present invention has been illustrated and described mainly about a specific embodiment. However, it is possible for those skilled in the art to add various modifications, if necessary, to the above-described embodiment with respect to the shape, position and/or disposition without departing from the technical spirit and the range of the object of the present invention.

For example, as for the washing means, it is not limited to the use of organic solvent L. As shown in FIG. 5, such an arrangement may be adopted that a rotation brush 50 is disposed as the washing means within the blade receiving portion 44, and the blade 21B is washed by the rotation brush 50. In this case, if necessary, the blade receiving portion 44 may be arranged to be filled with washing liquid.

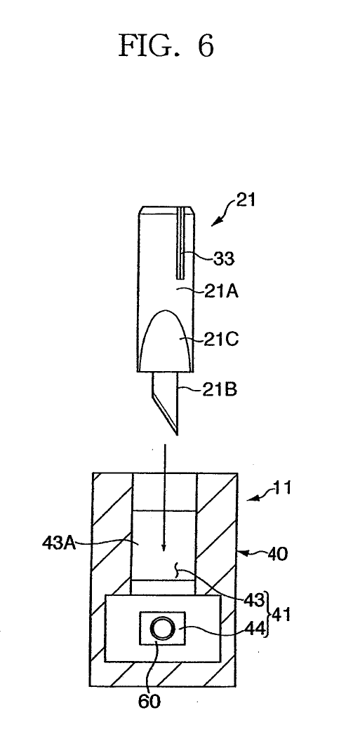

Also, as shown in FIG. 6, such an arrangement may be adopted that the blade receiving portion 44 is equipped with inspection means 60 constituted of a camera or the like capable of inspecting the surface of the blade 21B to inspect defects and the like on the blade 21B.

Although the organic solvent L is used to dissolve the adhesive and the like adhered on the blade 21B in the above-described embodiment, such an arrangement may be adopted that the blade 21B is washed with an ultrasonic vibrating device using water or the like as the washing liquid.

1-8. (canceled)

9. A sheet cutting apparatus, comprising:
a cutting device;
at least one cutter blade to be mounted detachably on the cutting device, the cutter blade having a blade holder and a blade fixed to the blade holder; and
a stocking device for storing the at least one cutter blade, wherein the stocking device comprises:
a case body,
a receiving section in the case body, said receiving section having a blade holder receiving portion for storing the blade holder and a blade receiving portion for storing the blade, and
a heater for heating the blade holder and the blade of said cutter blade in the receiving section,
wherein the cutting device is arranged for using the cutter blade heated by the heater.

10. The sheet cutting apparatus according to claim 9, further comprising, within said case body, inspection means for inspecting the blade of the at least one cutter blade when stored in said stocking device.

11. The sheet cutting apparatus according to claim 9, further comprising:
an orientation determining portion formed on the cutter blade, and
an engagement portion provided within the case body corresponding to the orientation determining portion for maintaining a storage position of the at least one cutter blade stored in said case body to be constant,.

12. The sheet cutting apparatus according to claim 9, wherein the case body includes washing means for washing said at least one cutter blade.

13. The sheet cutting apparatus according to claim 12, wherein said washing means contains a washing liquid within said case body.

14. The sheet cutting apparatus according to claim 12, wherein said washing means further includes an ultrasonic vibrating device for imparting ultrasonic vibration to the washing liquid.

15. The sheet cutting apparatus according to claim 12, wherein said washing means further includes a washing brush stored within the case body.

16. The sheet cutting apparatus according to claim 10, wherein
the inspection means includes a camera.

17. The sheet cutting apparatus according to claim 9, wherein
said heater extends along side both said blade holder receiving portion and said blade receiving portion for heating both the blade holder and the blade received in the blade holder receiving portion and the blade receiving portion, respectively.

18. The sheet cutting apparatus according to claim 9, wherein
the blade holder includes a lower end and slanted surfaces converging toward the lower end,
the blade projects downward from the lower end of the blade holder, and
the blade holder receiving portion has a pair of slanted walls for directly contacting the slanted surfaces of the cutter blade, respectively, in a wedge engagement to position the cutter blade in a predetermined storage position in said case body with the blade being oriented vertically.

19. The sheet cutting apparatus according to claim 18, wherein
said case body having an opening through which the cutter blade is to be introduced into the case body, and
the cutter blade is maintained in the storage position in the case body by the wedge engagement between the slanted surfaces and the respective slanted walls, without direct contact between the cutter blade and a periphery of the opening.
